(19) United States
(12) Patent Application Publication
(10) Pub. No.: US 2013/0227998 A1
(43) Pub. Date: Sep. 5, 2013

(54) FERTILISER

(71) Applicant: Christopher Copplestone, Richmond (NZ)

(72) Inventor: Christopher Copplestone, Richmond (NZ)

(21) Appl. No.: 13/884,589

(22) PCT Filed: Oct. 26, 2011
(86) PCT No.: PCT/NZ2011/000225

§ 371 Date: May 9, 2013

(30) Foreign Application Priority Data
Nov. 24, 2010 (NZ) 589461

(51) Int. Cl. C05B 17/00

(52) U.S. Cl. CPC C05B 17/00
USPC 71/24

(57) ABSTRACT

A fertiliser has phosphate rock of less than 500 μm; sulphur; carbon and/or coal, at least approximately half of which has a particle size of less than 350 μm and approximately all of which has a particle size of less than 1 mm; humic acid and/or fulvic acid (in each case contained in the coal/carbon and/or otherwise added); and a suitable binder.

### FIELD OF INVENTION

This invention relates to a fertiliser. A preferred form of the invention relates to a fertiliser for soil used in farming or horticultural applications.

### BACKGROUND

It is known to fertilise soil so as to improve its effectiveness for growing food crops. It is an object of a preferred form of the invention to go at some way towards providing a useful alternative fertiliser to known products.

Unless otherwise indicated all percentage amounts expressed in this document are on a weight basis.

### SUMMARY OF THE INVENTION

According to one aspect of the invention there is provided a fertiliser comprising:
a) phosphate rock of less than 500 μm;
b) sulphur;
c) carbon and/or coal, at least approximately half of which has a particle size of less than 350 μm and approximately all of which has a particle size of less than 1 mm;
d) humic acid and/or fulvic acid (in each case contained in the coal/carbon and/or otherwise added); and
e) a suitable binder.

Optionally the phosphate rock makes up from approximately 60% to approximately 80% of the fertiliser.

Optionally the fertiliser comprises approximately 5% to approximately 12% sulphur.

Optionally the phosphate rock has a particle size of less than approximately 350 μm.

Optionally approximately 75% of the coal has a particle size of less than 350 μm and approximately all of the coal has a particle size of less than 1 mm.

Optionally at least some of the humic acid and/or fulvic acid is contained within the coal.

Optionally the binder comprises a suitable sugar, a suitable starch or a suitable clay, or a combination of these.

Optionally the fertiliser comprises 2% to 4% humic acid and/or fulvic acid.

Optionally the fertiliser comprises humic acid and fulvic acid in combination in a weight ratio of approximately 10:1.

Optionally the fertiliser comprises approximately 1% to approximately 3% seaweed.

Optionally the fertiliser is formed into granules by applying water to the phosphate rock, sulphur, coal and the humic acid and/or fulvic acid. A suitable organic acid, for example citric acid, may be mixed into the water to facilitate pH adjustment.

Optionally the aqueous acid is citric acid.

Optionally the fertiliser has been produced by subjecting its ingredients to air or oven drying after it has been worked into a granular form.

Optionally the oven drying is at less than 110° C. and preferably at less than 70° C.

Optionally the fertiliser comprises carbon and/or coal, at least approximately half of which has a particle size of less than 350 μm and approximately all of which has a particle size of less than 500 μm.

### DETAILED DESCRIPTION

Some preferred forms of the invention with now be described by way of example although it should be appreciated that the invention is not limited to these.

In preferred embodiments of the invention a fertiliser is produced for use with food crops and/or pasture. This is achieved by placing the following dry ingredients into a blender and mixing these until they form a homogeneous mixture:
phosphate rock (ground to pass through a 350 μm mesh) wherein such rock has a phosphorus pentoxide (P₂O₅) content of approximately 31%;
sulphur;
coal, preferably containing 30-60% carbon and preferably ground so that 75% of it passes through a 350 μm mesh and approximately 100% of it passes through a 1 mm mesh (most preferably 100% of it passes through a 500 μm mesh);
fulvic or humic acid if there is insufficient in the coal for effective fertilisation;
seaweed which has been dried and ground so that at least approximately 75% of it passes through a 350 μm mesh and 100% of it passes through a 1 mm mesh; and
sugar ground so that approximately all of it is able to pass through a 1 mm mesh.

Preferably the phosphate rock is not subjected to acid treatment prior to introducing it to the other dry ingredients.

Aqueous organic acid, for example citric acid, is added as a granulating agent and mixing is continued until all ingredients are thoroughly mixed. The amount of organic acid used depends on the target pH of the fertiliser but in some cases it may be sufficient to provide an overall fertiliser pH of approximately 5.5 to approximately 7.5. The resulting mixture is then compacted by passing it between two indented rollers. This compresses the mixture to produce granules of approximately 1 mm to approximately 6 mm in size. The granules are air or oven dried at a temperature of approximately 70° C. They are then screened to remove particles less than 1 mm and to remove particles greater than 6 mm. The resulting fertiliser is then packaged for use.

Particularly preferred fertiliser formulations are prepared according to the above process using the following quantities of ingredients.

| | Fertiliser A | Fertiliser B |
|---|---|---|
| Ingredient | (% by weight) | (% by weight) |
| Phosphate rock | 67.5 | 75.2 |
| Sulphur | 9.5 | 11.27 |
| Coal fines | 18.13 | 10.25 |
| Fulvic acid | 0.7 | 0.7 |
| Seaweed | 2.3 | 2.3 |

| | Fertiliser C |
|---|---|
| Ingredient | (kg) |
| Phosphate rock | 999 |
| Sulphur | 140.6 |
| Seaweed | 34.04 |
| Coal fines | 201.24 |
| (able to pass through a 350 μm mesh) | |
| Coal fines | 67.08 |
| (at a maximum particle size of 1 mm, or | |
| most preferably to a maximum of 500 μm) | |
| Fulvic acid | 10.36 |
| Citric acid | 12.88 |
| Sugar | 14.80 |

It has been found that preferred forms of the invention, for example fertilisers A, B and C, provide synergistic benefits when used to treat soil. It is believed the different particle sizes of the coal fines (ie 350 μm to 1 mm) means that nutrients are available to the soil in a sustained release manner, smaller particles being available more quickly than the larger ones. Preferably the breakdown of the fertiliser to release nutrients takes place over a period of 12 months. In this regard it is believed the coal fines serve to hold nutrients for a period and thus reduce the likelihood of premature nutrient leaching.

In preferred forms of the invention the fertiliser contains approximately 4% to approximately 10% carbon.

In alternative embodiments of the invention the granules may be prepared using pan or drum granulation techniques as opposed to compaction between two rollers.

In some embodiments of the invention the sulphur may assist in breaking down the phosphate rock when the fertiliser has been applied to the soil.

While some embodiments of the invention have been described by way of example it should be appreciated that modifications and improvements can occur without departing from the scope of the following claims.

1. A fertiliser comprising:
a) phosphate rock of less than 500 μm;
b) sulphur;
c) at least one of carbon and coal, at least approximately half of which has a particle size of less than 350 μm and approximately all of which has a particle size of less than 1 mm;
d) humic acid and/or fulvic acid (in each case contained in the coal/carbon and/or otherwise added); and
e) a suitable binder.

2. A fertiliser according to claim 1, wherein the phosphate rock makes up from approximately 60% to approximately 80% of the fertiliser.

3. A fertiliser according to claim 1, comprising approximately 5% to approximately 12% sulphur.

4. A fertiliser according to claim 1, wherein the phosphate rock makes up from approximately 60% to approximately 80% of the fertiliser, wherein the fertiliser comprises approximately 5% to approximately 12% sulphur, and wherein the phosphate rock has a particle size of less than approximately 350 μm.

5. A fertiliser according to claim 1, wherein approximately 75% of the coal when present has a particle size of less than 350 μm and approximately all of the coal when present has a particle size of less than 1 mm.

6. A fertiliser according to claim 5, wherein at least some of the humic acid and/or fulvic acid is contained within the coal.

7. A fertiliser according to claim 6, wherein the binder comprises a suitable sugar, a suitable starch or a suitable clay, or a combination of these.

8. A fertiliser according to claim 1, wherein the fertiliser comprises 2% to 4% humic acid and/or fulvic acid.

9. A fertiliser according to claim 1, comprising humic acid and fulvic acid in combination in a weight ratio of approximately 10:1.

10. A fertiliser according to claims 1, comprising approximately 1% to approximately 3% seaweed.

11. A fertiliser according to claim 1, formed into granules by applying water to the phosphate rock, sulphur, coal and the humic acid and/or fulvic acid.

12. A fertiliser according to claim 1, comprising a suitable organic acid for regulating pH of the fertiliser.

13. A fertiliser according to claim 12, wherein the organic acid is citric acid.

14. A fertiliser according to claim 1, wherein the fertiliser has been air or oven dried after it has been worked into a granular form.

15. A fertiliser according to claim 14, wherein the air or oven drying is at less than 110° C.

16. A fertiliser according to claim 14, wherein the air or oven drying is at less than 70° C.

17. A fertiliser according to claim 1, wherein for part c) of claim 1 the fertiliser comprises carbon and/or coal, at least approximately half of which has a particle size of less than 350 μm and approximately all of which has a particle size of less than 500 μm.

18. A fertiliser comprising:
a) phosphate rock having a particle size of less 350 μm and which makes up from 60%-80% of the fertiliser;
b) sulphur which makes up 5%-12% of the fertiliser;
c) carbon and/or coal, at least approximately half of which has a particle size of less than 350 μm and approximately all of which has a particle size of less than 1 mm;
d) humic acid and/or fulvic acid (in each case contained in the coal/carbon and/or otherwise added);
e) a suitable binder;
f) humic and/or fulvic acid which makes up 2%4% of the fertiliser; and
g) an organic acid which regulates pH of the fertiliser.

19. A fertiliser according to claim 19 wherein the organic acid comprises citric acid.
